(19) United States
(12) Patent Application Publication
(10) Pub. No.: US 2014/0244281 A1
(43) Pub. Date: Aug. 28, 2014

(54) PHYSICIAN PRESCRIPTION PROCESSING

(71) Applicant: Complete Consent, LLC, Savannah, GA (US)

(72) Inventor: Sidney P. Smith, Savannah, GA (US)

(73) Assignee: Complete Consent, LLC, Savannah, GA (US)

(21) Appl. No.: 14/186,424

(22) Filed: Feb. 21, 2014

Related U.S. Application Data
(60) Provisional application No. 61/768,594, filed on Feb. 25, 2013.

(51) Int. Cl. G06F 19/00

(52) U.S. Cl. CPC G06F 19/3456
USPC 705/2

(57) ABSTRACT

Physicians providing education about prescriptions, storing this information for patient access, and adjudicating prescriptions can be compensated by patients for their efforts avoiding Stark and anti-kickback laws if the compensation is paid separately from a prescription. Additional compensation can be paid to physicians from pharmacies for patient education and adjudication. Adjudication in a physician's exam room increases efficiency, decreases patient sticker shock at pharmacies, assures patients are given the best price on a medical prescription and assures patients that all coupons or discount cards are used. In-office adjudication also allows physician/patient discussion of cost.

### CROSS-REFERENCES TO RELATED APPLICATIONS

This application claims the benefit of U.S. Provisional Patent Application Ser. No. 61/768,594, filed Feb. 25, 2013, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The invention relates to processing medical prescriptions and, more particularly, for efficiently processing medical prescriptions at a physician's office, for providing compensation to the physician for prescription adjudication, physician video education about prescriptions, and video/white paper storage with patient access.

Currently, no process exists enabling a physician to receive compensation for adjudicating a prescription, educating a patient about a prescription, or storing videos or printed material about prescriptions for patient access.

Traditionally, a physician provides a written prescription (Rx) to a patient that is hand-delivered to a pharmacy, or the physician uses software to electronically send a patient's prescription to the pharmacy. The pharmacist enters the patient's Pharmacy Benefit Plan (PBM) information and the prescription National Drug Code number (NDC), a unique identifying number for a medicine, into the pharmacy's software to see if the prescription is covered by the patient's insurance benefits (PBM) and how much the patient will pay for the medicine. This process is called adjudication.

Some medicines are not covered by a patient's insurance benefits and do not require adjudication. These prescriptions may be sent to the pharmacy or directly to the manufacturer for direct shipment to patients.

### SUMMARY OF THE INVENTION

The system and methodology of the preferred embodiments allow physicians to receive payment for an educational process, sending and storing this educational information on a secured server for unlimited patient access, for adjudicating a claim in the exam room, and for sending the adjudicated claims to a pharmacy. The process improves patient safety and compliance while also avoiding Stark and anti-kickback laws. Also, the process enables physicians to receive payment for an education process with videos and white papers, maintaining storage with patient access of education materials, and payment for prescription adjudication expenses.

The system and methodology for physicians to receive compensation improve upon existing standard office and pharmacy procedures. Pharmacy benefit information for patients may be recorded in the physician's office and not the pharmacy. Adjudication of the insurance covered prescription may occur in the physician's exam room with the patient, enabling patients to know what their prescription cost is before leaving the physician's office. This avoids the revolving door inefficiencies of patients going to the pharmacy, discovering the cost of an Rx, calling the physician, requesting an alternative Rx, the physician resending an alternate Rx, and possibility of repeating the entire process. Also, patients may be provided with a prescription education process including prerecorded videos about their prescription, sign consents, and receive printed information pertaining to their prescription. This process can be standardized nationally to improve patient education and safety. The physician-patient consultation about the diagnosis and prescription is recorded in the exam room. The patient receives a secured link to access the physician-patient consultation video, prescription educational video, and printed information. The patient pays the physician for the adjudication work, if performed, and for the educational materials, access and storage. The pharmacy contractually agrees to accept the prescription adjudication result and may pay an additional fee to the physician for the adjudication and patient education. The pharmacy contractually agrees to a contracted fee for non-insured medications. The pharmaceutical companies may compensate the software administrator enabling the system to perform the adjudication process and physician for adjudication work. Prescriptions not covered by insurance can be sent to the manufacturer for direct sales.

In an exemplary embodiment, a method for processing a medical prescription includes the steps of (a) providing a physician office with access to a patient's pharmacy benefit information; (b) using a computer processor to adjudicate the medical prescription from the physician office with the pharmacy benefit information; (c) sending adjudication information to a network pharmacy using network communication structure; (d) processing a payment by the patient for the medical prescription from the physician office; and (e) processing a payment by the patient for the adjudication.

The method may further include (f) educating the patient about the medical prescription. In this context, step (e) may be practiced by processing a payment by the patient for the adjudication and for the education.

The method may include obtaining a signature from the patient acknowledging informed consent, and/or the method may include (g) recording the educating. A link may be provided for the patient to access the recording. In this context, step (f) may be practiced by providing written materials with information relating to the medical prescription, step (g) may be practiced by storing the written materials, and the link may provide the patient with access to the written materials. The method may also include processing a payment from the network pharmacy for at least one of the adjudication, the educating, and the inclusion as the network pharmacy.

When step (b) determines that the medical prescription is not covered by the patient's pharmacy information, step (c) may be practiced by determining a price for the medical prescription.

Other exemplary embodiments include a computer program executable by a computer processor for processing a medical prescription, and a system for processing a medical prescription.

### BRIEF DESCRIPTION OF THE DRAWINGS

These and other aspects and advantages will be described in detail with reference to the accompanying drawings, in which:

FIG. 1 is a process diagram for processing a medical prescription; and

FIG. 2 is a detailed schematic illustration of a computer system.

### DETAILED DESCRIPTION OF THE INVENTION

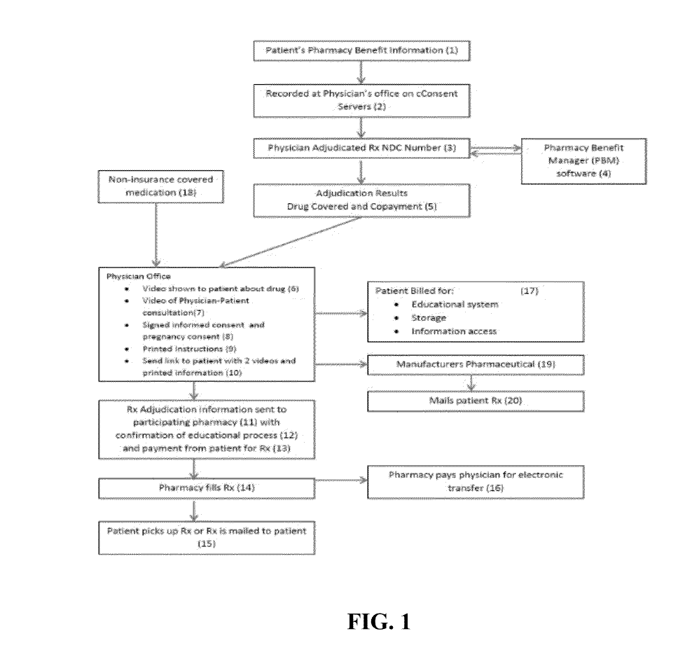

With reference to FIG. 1, a physician office (physician, nurse, staff, etc.) is provided with access to a patient's pharmacy benefit information (1), which is recorded into the physician's (or software administrator's) servers (2) to adjudicate patient prescriptions in the exam room. This information is used if a patient's insurance is billed or not used if the prescription is a non-insurance covered prescription. The PBM information (found on a patient's insurance card) is usually recorded at the pharmacy and used for pharmacy adjudication. The physician (with the NDC number) adjudicates the prescription (3) by querying the PBM software (4) for a patient and determines if a patient's prescription plan will pay for the medicine and what the copayment will be (5) (if the prescription is a non-covered item, no adjudication information is retrieved).

The physician may show an FDA-based standard video (6) to educate the patient about the prescription's indications, contraindications, risks, side effects, monitoring guidelines, drug interactions, and use in pregnancy, children or lactation (if applicable). Also, a physician-patient consultation video is recorded (7).

The patient signs an informed consent (8) and pregnancy form (if applicable). The patient then receives all information in printed form including a video transcript (9). The system then sends the patient a secured email link to view all printed material, educational video and physician-patient videos (10). The system then sends the adjudication information to a network pharmacy (11) or sends the prescription non-adjudicated if a non-covered item.

The pharmacy receives the adjudication information and prescription, confirmation of the completed education process (12), and payment from the patient (13) collected at the physician's office, all while the patient is in the physician's exam room. The pharmacist fills the prescription (14), and the patient picks up the prescription (15) at the pharmacy or it is mailed to the patient's address.

The physician is compensated by the patient separately from the Rx payment (17) for having completed the adjudication, for the educational system and for storage and access of information. The physician may also receive compensation from the pharmacy for the adjudication and patient education as well (16). The patient also separately pays the physician for the Rx, which is forwarded to the pharmacy.

A prescription not covered by the patient's pharmacy benefits (18) is not adjudicated, but the patient proceeds through the same educational process (6) and payment method. The prescription is either sent to a pharmacy (14) contracted to sell prescriptions at a set price through the program or sent to a contracted manufacturer (19). The patient pays the physician for the education, storage and information access and separately pays the physician for the Rx, which is forwarded to the manufacturer or pharmacy. The manufacturer or pharmacy processes (19) and mails the prescription (20).

The patient paying for the service provided by the physician and drug cost separately avoids any Stark and anti-kickback laws. The prices of the medications are contractually set by the software. The system enables patient access to volume discounts that would not be possible if the prescription was presented to another pharmacy.

Pharmacies are eager to participate, as the cost to dispense is less, the prescriptions are prepaid, no adjudication time is involved, and the patient education has been documented. Physicians are eager to participate as they receive compensation for their additional efforts, know the patients are receiving the correct medicines, and appreciate the added safety through the process. Also, by adjudicating in the exam room, patients know the cost of medications and can discuss this with their physicians before leaving the office. This avoids the patients leaving a physician's office to only find out the cost of an Rx at the pharmacy. Also, physicians can make sure all coupons or discount cards are properly used to assure patients receive the best medicine price, because some pharmacies purposefully do not adjudicate coupons as this would decrease their profits.

The prescription program described with reference to FIG. 1 is preferably a browser-based system in which a program running on a user's computer (the user's web browser) requests information from a server program running on a system server. The system server sends the requested data back to the browser program, and the browser program then interprets and displays the data on the user's computer screen. The process is as follows:

1. The user runs a web browser program on his/her computer.

2. The user connects to the server computer (e.g., via the Internet). Connection to the server computer may be conditioned upon the correct entry of a password as is well known.

3. The user requests a page from the server computer. The user's browser sends a message to the server computer that includes the following:

the transfer protocol (e.g., http://); and

the address, or Uniform Resource Locator (URL).

4. The server computer receives the user's request and retrieves the requested page, which is composed, for example, in HTML (Hypertext Markup Language).

5. The server then transmits the requested page to the user's computer.

6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the account management system of the present invention include Mozilla Firefox® and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the system described below and illustrated in the accompanying drawings.

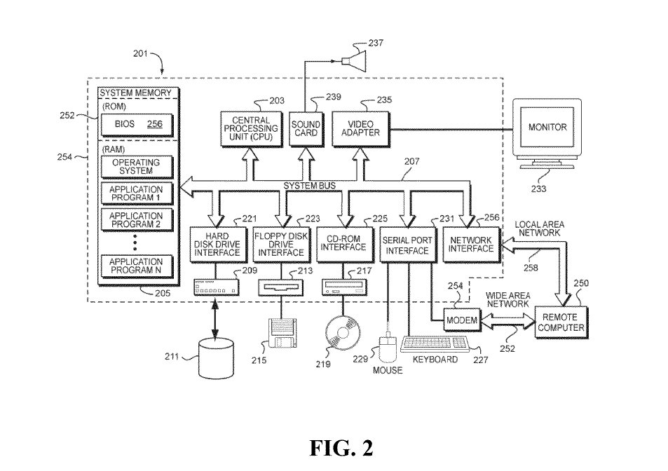

FIG. 2 generally illustrates a computer system 201 suitable for use as the client and server components of the described system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem or broadband or wireless adapter 237 or other means for establishing communications over the wide area network 239, such as the Internet. The modem 237, which may be internal or external, is connected to the system bus 207 via the serial port interface 231. A network interface 241 may also be provided for allowing the computer system 201 to communicate with a remote computing device 250 via a local area network 258 (or such communication may be via the wide area network 239 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method for processing a medical prescription, the method comprising:
(a) providing a physician office with access to a patient's pharmacy benefit information;
(b) using a computer processor to adjudicate the medical prescription from the physician office with the pharmacy benefit information;
(c) sending adjudication information to a network pharmacy using network communication structure;
(d) processing a payment by the patient for the medical prescription from the physician office; and
(e) processing a payment by the patient to the physician office for the adjudication.

2. A method according to claim 1, further comprising (f) educating the patient about the medical prescription.

3. A method according to claim 2, wherein step (e) is practiced by processing a payment by the patient separate from the medical prescription for the adjudication, for the education, and for data storage/access by the patient.

4. A method according to claim 2, further comprising obtaining a signature from the patient acknowledging informed consent.

5. A method according to claim 2, further comprising (g) recording the educating.

6. A method according to claim 5, further comprising providing a link for the patient to access the recording.

7. A method according to claim 6, wherein step (f) is practiced by providing written materials with information relating to the medical prescription, wherein step (g) is practiced by storing the written materials, and wherein the link provides the patient with access to the written materials.

8. A method according to claim 1, wherein when step (b) determines that the medical prescription is not covered by the patient's pharmacy information, step (c) is practiced by determining a price for the medical prescription.

9. A method according to claim 1, further comprising processing a payment from the network pharmacy to the physician office for at least one of the adjudication, the educating, and the inclusion as the network pharmacy.

10. A computer program embodied on a non-transitory computer readable medium and executable by a computer processor for processing a medical prescription by:
(a) accessing a patient's pharmacy benefit information at a physician office;
(b) adjudicating the medical prescription from the physician office with the pharmacy benefit information;
(c) sending adjudication information to a network pharmacy using network communication structure;
(d) processing a payment by the patient for the medical prescription from the physician office; and
(e) processing a payment by the patient for the adjudication.

11. A computer program according to claim 10, further comprising (f) displaying an informational video to educate the patient about the medical prescription.

12. A computer program according to claim 11, wherein step (e) is practiced by processing a payment by the patient for the adjudication and for the education.

13. A computer program according to claim 11, further comprising (g) recording the educating.

14. A computer program according to claim 13, further comprising providing a link for the patient to access the recording.

15. A computer program according to claim 14, wherein step (f) is practiced by providing written materials with information relating to the medical prescription, wherein step (g) is practiced by storing the written materials, and wherein the link provides the patient with access to the written materials.

16. A computer program according to claim 10, wherein when step (b) determines that the medical prescription is not covered by the patient's pharmacy information, step (c) is practiced by determining a price for the medical prescription.

17. A system for processing a medical prescription, the system comprising:
(a) means for accessing a patient's pharmacy benefit information at a physician office;
(b) means for adjudicating the medical prescription from the physician office with the pharmacy benefit information;
(c) means for sending adjudication information to a network pharmacy;
(d) means for processing a payment by the patient for the medical prescription from the physician office; and
(e) means for processing a payment by the patient for the adjudication.
